(19) United States
(12) Patent Application Publication
(10) Pub. No.: US 2024/0190647 A1
(43) Pub. Date: Jun. 13, 2024

(54) TRASH BIN BACKBOARD APPARATUS

(71) Applicant: Folarin O. SOSAN, Burtonsville, MD (US)

(72) Inventor: Folarin O. SOSAN, Burtonsville, MD (US)

(21) Appl. No.: 18/534,338

(22) Filed: Dec. 8, 2023

Related U.S. Application Data
(60) Provisional application No. 63/431,053, filed on Dec. 8, 2022.

(51) Int. Cl. B65F 1/08

(52) U.S. Cl. CPC B65F 1/08; B65F 1/14

(57) ABSTRACT

A trash bin backboard apparatus including a base is disclosed. The base may include one or more base walls. The base may be configured to be shaped as a chute by folding the base walls. The base may be further configured to be secured in an interior portion of a trash bin or secured to an exterior portion of the trash bin. Further, at least a portion of the base walls may be disposed outside the trash bin and above a top periphery of the trash bin, when the base may be secured in the interior portion of the trash bin or secured to the exterior portion of the trash bin.

### TECHNICAL FIELD

The present disclosure relates to a shield or a backboard apparatus for a trash bin, and more particularly, to a backboard apparatus that funnels the trash thrown towards the trash bin into a track interior portion.

### BACKGROUND

Trash bins are placed in residential and commercial buildings to enable users to conveniently dispose of trash. The trash bins are typically placed in front of the walls or in the corners. Users often throw the trash towards the trash bins. There are known instances of the thrown trash missing the trash bins and hitting the walls behind the trash bins. Such instances typically result in making the walls or the floor on which the trash bin is placed dirty and unhygienic.

Therefore, an apparatus is required to prevent the trash from missing the trash bin, when the trash is thrown towards the trash bin.

It is with respect to these and other considerations that the disclosure made herein is presented.

### BRIEF DESCRIPTION OF THE DRAWINGS

The description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a top isometric view of a conventional trash bin.

FIG. 2 depicts an isometric view of a trash bin backboard apparatus in accordance with the present disclosure.

FIG. 3 depicts a view of a base of the trash bin backboard apparatus of FIG. 2 with fold lines in accordance with the present disclosure.

FIG. 4 depicts a view of the trash bin backboard apparatus secured in the trash bin in accordance with the present disclosure.

FIG. 5 depicts a view of a trash bin backboard apparatus having one or more connectors connected to a rim of a trash bin in accordance with the present disclosure.

FIG. 6 depicts walls of the trash bin backboard apparatus of FIG. 5 with the connectors in accordance with the present disclosure.

FIG. 7 depicts a first semi-circular trash bin backboard apparatus secured in a circular trash bin in accordance with the present disclosure.

FIG. 8 depicts a graphic disposed on a wall of a trash bin backboard apparatus secured in a trash bin in accordance with the present disclosure.

FIG. 9 depicts a top isometric view of a trash bin without a rim.

FIG. 10 depicts an isometric view of another trash bin backboard apparatus in accordance with the present disclosure.

FIG. 11 depicts an isometric view of the trash bin backboard apparatus of FIG. 10 secured in the trash bin of FIG. 9, in accordance with the present disclosure.

FIG. 12 depicts a second semi-circular trash bin backboard apparatus in accordance with the present disclosure.

FIG. 13 depicts the trash bin backboard apparatus of FIG. 12 secured in the circular trash bin of FIG. 7, in accordance with the present disclosure.

FIG. 14 depicts the trash bin backboard apparatus of FIG. 12 with a connector disposed on an inside wall of the trash bin backboard apparatus, in accordance with the present disclosure.

FIG. 15 depicts a trash bin backboard apparatus where the base of the trash bin backboard apparatus is outside the trash bin of FIG. 9, in accordance with the present disclosure.

### DETAILED DESCRIPTION

### Overview

The present disclosure describes a trash bin backboard apparatus (“apparatus”) that prevents trash thrown at a trash bin from hitting the walls behind the trash bin, when the apparatus is attached to the trash bin. The apparatus may include a base made of flexible or rigid material. For example, the base may be made of rigid or semi-rigid material such as cardboard, plastic, or sheet metal. The base may include one or more base walls, and the base may be configured to be shaped as a chute when a user folds the base walls. The base may be configured to be secured in an interior portion of the trash bin such that the exterior surfaces of the base walls face the interior surfaces of one or more trash bin walls. The trash bin walls are rigid. Further, at least a portion of the base walls may be disposed outside the trash bin and above a top periphery of the trash bin, when the base may be secured in the interior portion of the trash bin. In some aspects, the portion of the base walls disposed outside the trash bin and above the top periphery of the trash bin is less than 70% of a base length. Stated another way, more than 30% of the base length may be secured in the interior portion of the trash bin.

In some aspects, the base may include three walls, e.g., a first wall, a second wall and a third wall. The first wall, the second wall and the third wall may form an integrated structure of the base. An intersection edge (e.g., a first intersection edge) of the first wall and the second wall may be flexible. Further, the first wall and the second wall may be configured to be moved relative to each other via the first intersection edge such that a plane of the first wall forms a first predefined angle relative to a plane of the second wall. Similarly, an intersection edge (e.g., a second intersection edge) of the third wall and the second wall may be flexible, and the third wall and the second wall may be configured to be moved relative to each other via the second intersection edge such that a plane of the third wall forms a second predefined angle relative to the plane of the second wall.

In an exemplary aspect, the first predefined angle may be equivalent to the second predefined angle, which in turn may be equivalent to 90 degrees. In some aspects, the first predefined angle and the second predefined angle may be based on a shape of the interior portion of the trash bin.

In further aspects, at least one base wall may include a connector disposed on a middle section of the wall and configured to attach the base wall to a top portion of at least one trash bin wall. In an exemplary aspect, the connector may be formed of a folded cut-out section of the base wall. The connector may be shaped as a wedge and configured to be positioned under a rim of the trash bin.

In some aspects, the connector may include a locking mechanism configured to lock the connector with the rim or the top portion of the trash bin wall. The locking mechanism may include, for example, an adhesive, a Velcro™ tape, one or more snap buttons, a protrusion-and-hole locking arrangement, and/or the like.

In some aspects, a bottom edge of at least one base wall touches a bottom interior surface of the trash bin when the base may be secured in the interior portion of the trash bin. Further, in some aspects, the exterior surfaces of the base walls may touch the interior surfaces of one or more trash bin walls when the base may be secured in the interior portion of the trash bin.

In accordance with another embodiment of the present disclosure, a trash bin backboard apparatus is disclosed that includes a base and a connector. The base may include one or more walls, and the base may be configured to be shaped as a chute by folding the walls. The base may be further configured to be disposed outside of a trash bin and secured to a trash bin exterior wall. Further, at least a portion of the walls is disposed outside the trash bin and above a top periphery of the trash bin. In some aspects, the portion of the walls disposed outside the trash bin and above the top periphery of the trash bin is less than 70% of a base length. Stated another way, more than 30% of the base length may be secured in the interior portion of the trash bin. In addition the connector may be disposed on or originates from a middle section of at least one wall of the base walls described above. The connector may be configured to attach the base wall to a top portion of at least one trash bin wall (which may be rigid).

The present disclosure discloses a trash bin backboard apparatus, which when attached to a trash bin, prevents the trash thrown towards the trash bin from hitting the wall behind the trash bin, thereby protecting the wall from getting dirty. The apparatus also funnels and redirects the trash that hits the apparatus into the opening or the interior portion of the trash bin.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

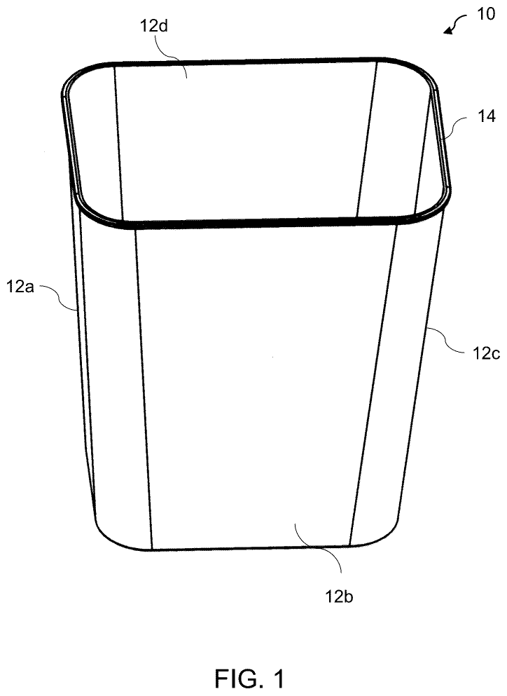

FIG. 1 depicts a top isometric view of a conventional trash bin 10. The trash bin 10 may be of any shape, e.g., cuboidal, cylindrical, etc. In the exemplary aspect depicted in FIG. 1, the trash bin 10 is cuboidal in shape having four trash bin walls 12a, 12b, 12c and 12d (collectively referred to as trash bin walls 12). The trash bin walls 12a and 12c may be parallel to each other, and perpendicular to the trash bin walls 12b and 12d. The trash bin walls 12 may be rigid.

The trash bin 10 may include a hollow interior portion, and may have a closed bottom portion (not shown). The trash bin 10 may include an open top portion, which may enable a user to throw trash into the interior portion of the trash bin 10. The trash bin 10 may further include a rim 14 that may be formed at the top edges of the trash bin walls 12. The rim 14 may enable the user to conveniently hold the trash bin 10 and move from one location to another, when the user desires to move the trash bin 10.

In some aspects, the trash bin 10 may have a tapered shape, such that a length and a width of the open top portion of the trash bin 10 may be greater than a length and a width of the closed bottom portion of the trash bin 10.

The shape of the trash bin 10 shown in FIG. 1 should not be construed as limiting, and the trash bin 10 may have any other shape without departing from the scope of the present disclosure.

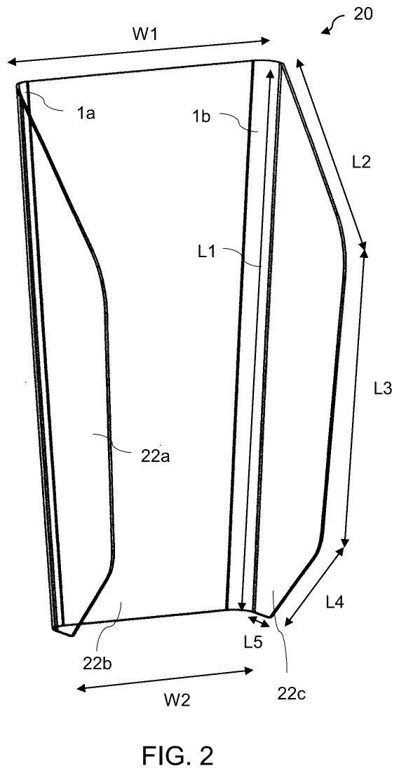

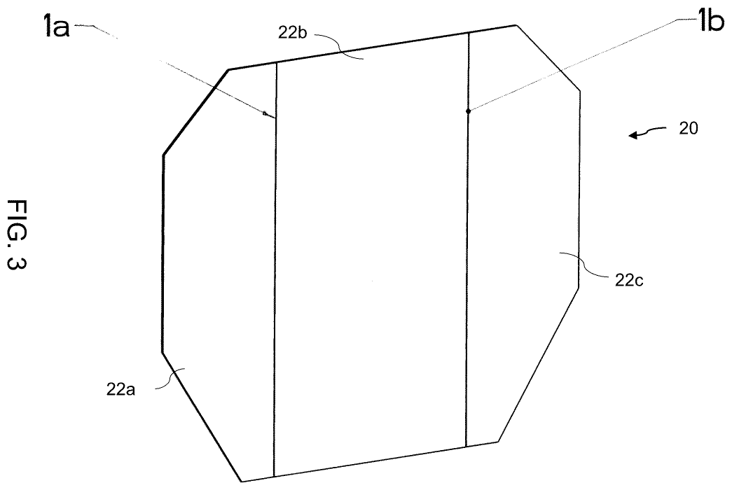

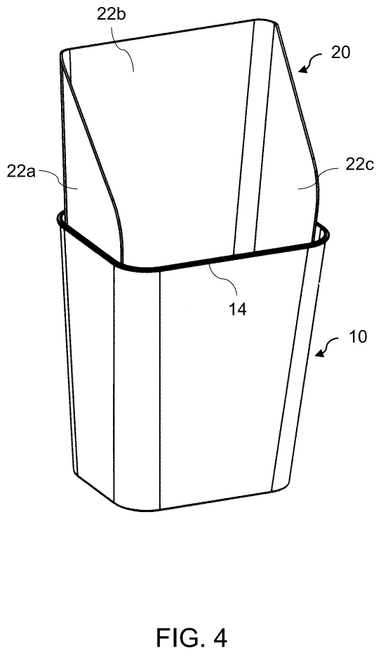

FIG. 2 depicts an isometric view of a trash bin backboard apparatus (“apparatus”) in accordance with the present disclosure. While describing FIG. 2, references will be made to FIGS. 3 and 4. The apparatus may include a base 20 that may be made of rigid or flexible material. For example, the base 20 may be made of rigid or semi-rigid material including, but not limited to metal, plastic, cardboard, and/or the like. The base 20 may include one or more flat base walls that may be folded such that the base 20 may be shaped as a chute. Responsive to folding the base walls, the base 20 may be inserted into the interior portion of the trash bin 10, as shown in FIG. 4. When the base 20 may be inserted in the interior portion of the trash bin 10, the base 20 may catch and redirect/funnel the trash thrown towards into the trash bin 10 into the interior portion of the trash bin 10. In this manner, the base 20 acts as a “shield” for the building walls disposed behind or beside the trash bin 10 when the base 20 may be inserted into the trash bin 10, and does not allow the trash to hit the building walls.

In the exemplary aspect depicted in FIG. 2, the base 20 includes three base walls, e.g., a first wall 22a, a second wall 22b and a third wall 22c. The first, second and third walls 22a-c may form an integrated structure of the base 20. Stated another way, the first, second and third walls 22a-c may be formed of a single sheet of material of the base 20. The second wall 22b may be disposed between the first wall 22a and the third wall 22c, as shown in FIGS. 2, 3 and 4.

Each base wall may have same thickness, but may have different dimensions based on the shape and dimensions of the trash bin 10 (or the trash bin walls 12). For example, the second wall 22b may have a tapered rectangular shape such that a width “W1” of a top portion of the second wall 22b may be greater than a width “W2” of a bottom portion of the second wall 22b. The tapered shape of the second wall 22b may be similar to the tapered shape of the trash bin walls 12b or 12d. Such a tapered shape of the base 20 enables the base 20 to be securely placed or inserted into the interior portion of the trash bin 10.

In some aspects, if the trash bin 10 does not have a tapered shape, the second wall 22b may also not have a tapered shape. The shape of the second wall 22b may correspond to the shape of the trash bin walls 12b or 12d.

In an exemplary aspect, the first and third walls 22a, 22c may be shaped such that the first and third walls 22a, 22c may securely fit between the trash bin walls 12b and 12d, when the base 20 may be inserted into the interior portion of the trash bin 10. Each of the first and third walls 22a, 22c may include one or more edges. For example, in the exemplary aspect depicted in FIG. 2, each of the first and third walls 22a, 22c includes five edges, i.e., a first edge “L1”, a second edge “L2”, a third edge “L3”, a fourth edge “L4” and a fifth edge “L5”.

A length of the first edge “L1” may be equivalent to the length of the side edges of the second wall 22b. Further, the first edge “L1” may be disposed at an angle of 90 degrees relative to the fifth edge “L5”. The first edge “L5” may be disposed parallel to the bottom surface of the trash bin 10 when the base 20 may be inserted into the interior portion of the trash bin 10. In some aspects, the first edge “L5” (in addition to the bottom edge of the second wall 22b) may touch the bottom surface of the trash bin 10 when the base 20 may be inserted into the interior portion of the trash bin 10. The fifth edge “L5” and the bottom edge of the second wall 22b may enable the base 20 to be securely placed on top of the bottom surface of the trash bin 10 when the base 20 may be inserted into the interior portion of the trash bin 10.

The second edge “L2” and the fourth edge “L4” may be disposed at a predefined angle relative to the third edge “L3”. The second edge “L2” may be connected to the first edge “L1” and the third edge “L3”, and the fourth edge “L4” may be connected to the fifth edge “L5” and the third edge “L3”. Further, in some aspects, the third edge “L3” may be parallel to the first edge “L1”. In other aspects, the third edge “L3” may not be parallel to the first edge “L1”.

The lengths of the first to fifth edges L1-L5 may depend on the dimensions of the first, second and third walls 22a, 22b and 22c, and the shape and dimensions of the trash bin 10. The shape of the base 20 depicted in FIG. 2 should not be construed as limiting the present disclosure. The base 20 may have any other shape that may enable the base 20 to be securely placed inside the trash bin 10, without departing from the scope of the present disclosure.

The exterior surfaces of the first, second and third walls 22a, 22b and 22c may face the interior surfaces of the trash bin walls 12 when the base 20 may be inserted and secured in the interior portion of the trash bin 10. In some aspects, the exterior surfaces of the first, second and third walls 22a, 22b and 22c may touch the interior surfaces of the trash bin walls 12 when the base 20 may be inserted and secured in the interior portion of the trash bin 10, as shown in FIG. 4. In other aspects, the exterior surfaces of one or more walls from the first, second and third walls 22a, 22b and 22c may not touch the interior surfaces of the trash bin walls 12 when the base 20 may be inserted and secured in the interior portion of the trash bin 10. Further, as described above, the fifth edge “L5” and/or the bottom edge of the second wall 22b may touch the bottom interior surface of the trash bin 10 when the base 20 may be secured in the interior portion of the trash bin 10.

In some aspects, the dimensions of the first, second and third walls 22a-c may be such that the base 20 may barely fit into the trash bin 10, so that the base 20 may be wedged into the trash bin 10. Stated another way, the apparatus may be wedged and secured inside the trash bin 10 due to its walls making a tight fit with the walls of the trash bin 10 (as shown in FIG. 4). This may enable the base 20 to resist the impact of the trash that may hit the base 20 (without being dislodged from the trash bin 10), when a user throws the trash towards the trash bin 10. In some aspects, at least a portion of the first, second and third walls 22a-c may be disposed outside the trash bin 10 and above a top periphery (or the rim 14) of the trash bin 10, when the base 20 may be secured in the interior portion of the trash bin 10. The portions of the first, second and third walls 22a-c that are outside the trash bin 10 are configured to receive the trash thrown towards the trash bin 10 and redirect/funnel the trash towards the trash bin interior portion, thereby preventing the building walls from getting dirty or smeared due to the thrown trash. In some aspects, the portion of the first, second and third walls 22a-c disposed outside the trash bin 10 and above the top periphery (or the rim 14) of the trash bin 10 is less than 70% of a length of the base 20 (or “base length”). Stated another way, more than 30% of the base length may be secured inside the interior portion of the trash bin 10.

In some aspects, the base 20 may further include a first fold line 1a or a first intersection edge/portion of the first wall 22a and the second wall 22b, as shown in FIGS. 2 and 3. The first fold line 1a may be flexible, and the first wall 22a may be configured to be moved/folded relative to the second wall 22b via the first fold line 1a such that a plane of the first wall 22a forms a first predefined angle relative to a plane of the second wall 22b. An unfolded view of the first wall 22a and the second wall 22b is shown in FIG. 3, and a folded view of the first wall 22a and the second wall 22b is shown in FIG. 2. In the exemplary aspect depicted in FIG. 2, the first predefined angle is equivalent to 90 degrees. In some aspects, the first predefined angle may be based on the shape of the interior portion of the trash bin 10, so that the base 20 may be securely placed in the interior portion of the trash bin 10.

In a similar manner, the base 20 may include a second fold line 1b or a second intersection edge/portion of the third wall 22c and the second wall 22b, as shown in FIGS. 2 and 3. The second fold line 1b may be flexible, and the third wall 22c may be configured to be moved/folded relative to the second wall 22b via the second fold line 1b such that a plane of the third wall 22c forms a second predefined angle relative to the plane of the second wall 22b. An unfolded view of the third wall 22c and the second wall 22b is shown in FIG. 3, and a folded view of the third wall 22c and the second wall 22b is shown in FIG. 2. In the exemplary aspect depicted in FIG. 2, the second predefined angle is equivalent to 90 degrees. In some aspects, the second predefined angle may be based on the shape of the interior portion of the trash bin 10, so that the base 20 may be securely placed in the interior portion of the trash bin 10. In further aspects, the first predefined angle may be equivalent to the second predefined angle.

In some aspects, the user may fold the first and third walls 22a, 22c relative to the second wall 22b via the first and second fold lines 1a, 1b when the user may be installing or inserting the base 20 in the interior portion of the trash bin 10. In other aspects, a manufacturer of the base 20 may pre-fold the first and third walls 22a, 22c relative to the second wall 22b during the manufacturing of the base 20.

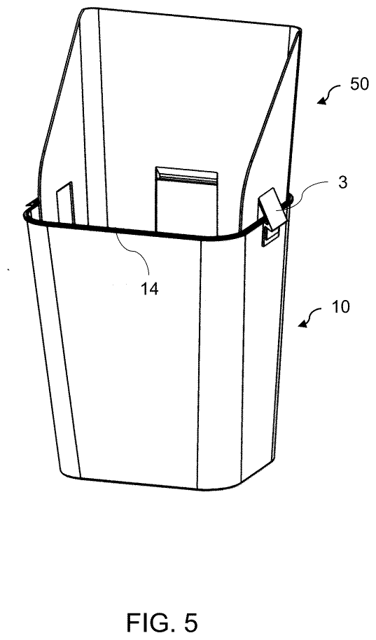

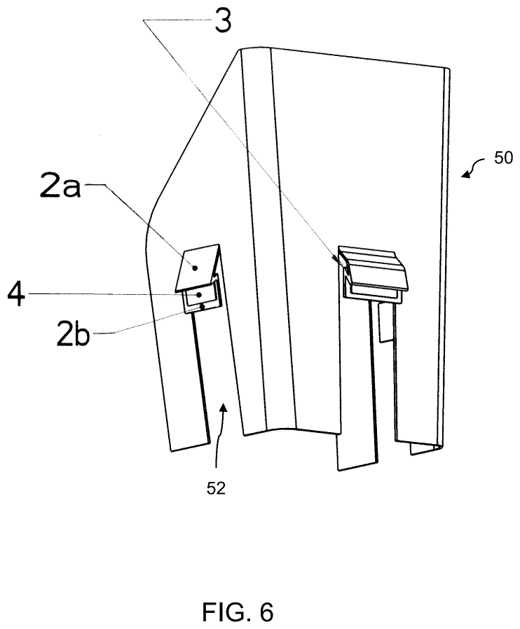

FIG. 5 depicts a view of a trash bin backboard apparatus (“apparatus”) having one or more connectors 3 connected to the rim 14 of the trash bin 10 in accordance with the present disclosure. FIG. 5 will be described in conjunction with FIG. 6.

The apparatus depicted in FIG. 5 may be similar to the apparatus depicted in FIG. 2, and may include a base 50. The base 50 may include three base walls, similar to the first, second and third walls 22a-c of the base 20 described above in conjunction with FIG. 2. However, one or more base walls of the base 50 may include a connector 3, as shown in FIGS. 5 and 6. The connector 3 may be configured to attach the base wall to the top portion or the rim 14 of the trash bin wall, when the base 50 may be placed over the rim 14 or when the base 50 may be inserted in the interior portion of the trash bin 10.

In some aspects, the connector 3 may be shaped as a wedge and formed of a folded cut-out section of the base wall. The wedge-shaped connector 3 may be configured to be positioned under the rim 14 of the trash bin 10. When the base 50 may be inserted in the interior portion of the trash bin 10, the wedge-shaped connector 3 may overlap or “rest” on the rim 14, thereby firmly securing the base 50 to the trash bin 10. In the exemplary aspect depicted in FIGS. 5 and 6, all the three base walls of the base 50 include a connector 3. In other aspects (not shown), one or more base walls (and not all base walls) may include the connector 3. For example, the two side base walls may include the connector 3, and the back base wall may not include any connector.

When the apparatus/base 50 includes the connector 3 (as shown in FIGS. 5 and 6), the base 50 may not be required to rest on the bottom interior surface of the trash bin 10, when the base 50 may inserted in the interior portion of the trash bin 10. In this case, the connector 3 may enable secure and robust attachment between the base 50 and the trash bin 10, and hence the base bottom edges may not be required to be rested on the bottom interior surface of the trash bin 10. In alternative aspects, the base bottom edges may still be rested on the bottom interior surface of the trash bin 10 to provide additional stability to the attachment between the base 50 and the trash bin 10.

Although the description above describes an aspect where the wedge-shaped connector 3 is formed of a folded cut-out section of the base wall, the present disclosure is not limited to such an aspect. In some instances, the connector 3 may be a separate piece (not formed from a cut-out section of the base wall) that may be attached to the base wall. In this case, the base wall may not include any aperture (e.g., aperture 52 shown in FIG. 5) that is formed from the cut-out section. Further, in this case, the connector 3 may be solid and not foldable. In some aspects, the connector 3 may originate from a middle section of a base wall.

In some aspects, when the wedge-shaped connector 3 is formed of a foldable cut-out section of the base wall, the connector 3 may include an upper connector section 2a and a lower connector section 2b, as shown in FIG. 6. The “V” shaped or wedge-shaped connector 3 may be formed by folding the cut-out section of the base wall in an approximately “Z” shape with the lower fold of the “Z” include the wedge that fits under the rim 14 of the trash bin 10. The upper and lower connector sections 2a, 2b of the “Z” fold form the connector 3 when folded together.

In some aspects, the connector 3 may further include a locking mechanism 4 configured to lock the connector 3 with the top portion of the trash bin wall or the rim 14. Specifically, the locking mechanism 4 may be configured to glue or attach the upper connector section 2a and the lower connector section 2b together, when the upper and lower connector sections 2a, 2b may be pressed against each other, after the connector 3 is placed over the rim 14. In some aspects, the connector 3 may maintain its shape when the upper and lower connector sections 2a, 2b may be glued or secured together.

The locking mechanism 4 may be one or more of a double-sided adhesive tape, a Velcro™ tape, one or more snap buttons, a protrusion-and-hole locking arrangement, interlocking indentations, and/or the like.

In some aspects, it may be apparent from the description above and FIGS. 5 and 6 that the connector 3 may be a piece connected to the base 50 above the rim 14 of the trash bin 10 extending from above the rim 14 of the trash bin 10 to a position beneath the rim 14 of the trash bin 10, with a middle portion shaped into a wedge shape that fits into the hollow under the rim 14 of the trash bin 10, and having a locking feature (e.g., the locking mechanism 4) to maintain the wedge tightly under the rim 14 of the trash bin 10, thus securing the base 50 to the trash bin 14.

The connector 3 may be a folded-cut-out portion of the base 50, folded into opposing leaves which secures the wedge under the rim 14 of the trash bin 10 when the leaves are pressed together, the locking element (or the locking mechanism 4) being disposed between the leaves.

This arrangement is for a base which is inside the trash bin 10 since the folded connector is on the outside of the trash bin 10; the trash bin 10 being trapped between the folded connector on the outside and the portions of the base inside the trash bin 10. The folded connector serves to clap or lock the base to the rim of the trash bin.

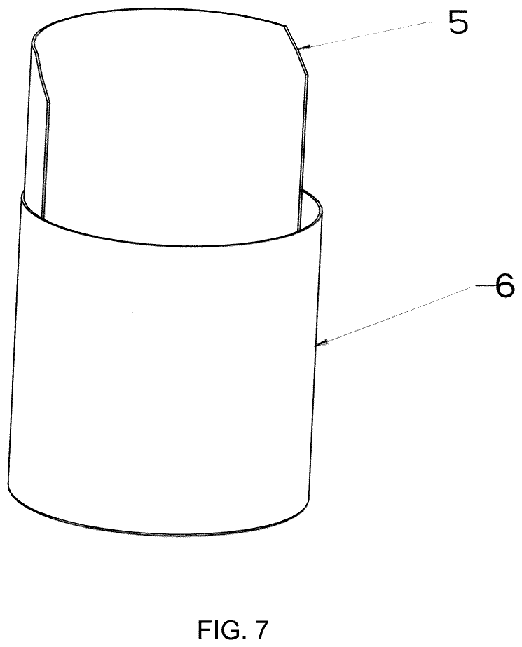

FIG. 7 depicts a first semi-circular trash bin backboard apparatus 5 (or apparatus 5) secured in a circular trash bin 6 in accordance with the present disclosure. In the exemplary aspect depicted in FIG. 7, the apparatus 5 is made of a base having a single wall, which is folded to fit in the interior portion of the trash bin 6. Stated another way, the apparatus 5 is wedged and secured inside the trash bin 6 (such that the apparatus walls tightly fit inside the trash bin walls, which may be rigid). In this case, the apparatus 5 may be attached to the interior portion of the trash bin 6 by using glue/adhesive, magnets, clips including spring loaded clips, and/or the like.

In a manner similar to the one depicted in FIG. 7, a trash bin backboard apparatus may be made for different shapes including, but not limited to, oval and polygonal shapes. An oversized base, if made of thin plastic or cardboard, may be trimmed to fit the shape and size of a trash bin either in a flat form or in its formed shape. The base may also be pre-formed in its rigid finished shape. The base may include a single wall that is attached to the trash bin, or made of multiple walls at different angles relative to each other.

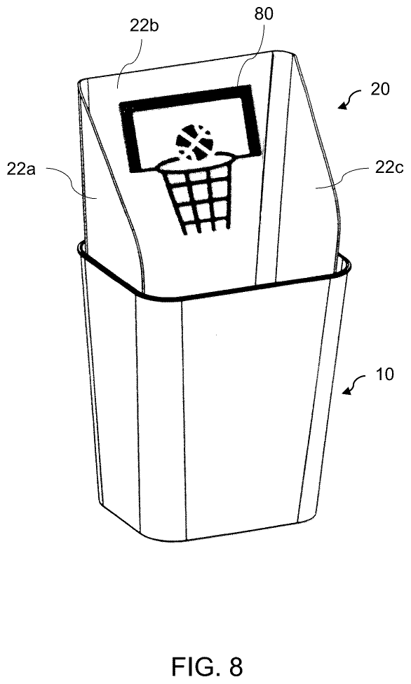

FIG. 8 depicts a graphic 80 disposed on the second wall 22b of the base 20 of the trash bin backboard apparatus secured in the trash bin 10 in accordance with the present disclosure. The graphic 80 is shown to include a basketball backboard, a basketball and a basket, inserted into a trash bin.

The graphic 80 may encourage the user to throw the trash into the trash bin 10, and contribute to the cleanliness of the surroundings. The graphic 80 may also be logos (e.g., of stores, basketball teams or franchises) or other artwork that serve as instructions or advertisements. The graphic 80 may be laminated with clear plastic to protect the graphic 80 from damage from the trash and prolong the graphic's use. Further, the graphic 80 may have artwork on both the sides, so that the graphic 80 is reversible.

The base 20 may be cleaned when dirty, or discarded. The graphic 80 may also be in a clear pouch or a clear laminated pouch that adheres tightly to the paper of the graphic 80 to protect it from being soiled by trash impacting it.

In some aspects, the base 20 may also be used with a trash bin liner by placing it inside the trash bin on top of the liner, so that the bottom of the base 20 rests on the liner. Alternatively, if the connector 3 is used, the base 20 may simply be attached to the edges of the trash bin over the trash liner.

In further aspects, two images or graphics may be disposed on either side of a laminated sheet on the base 20 so that flipping the laminated sheet over may display the second image. In this way, the base 20 may use different images/graphics, e.g., for different events or different settings.

Although the description above describes an aspect where the trash bin backboard apparatus is secured to a trash bin (e.g., the trash bin 10) having a rim (e.g., the rim 14) at the trash bin top edges, the present disclosure is not limited to such an aspect, as described below.

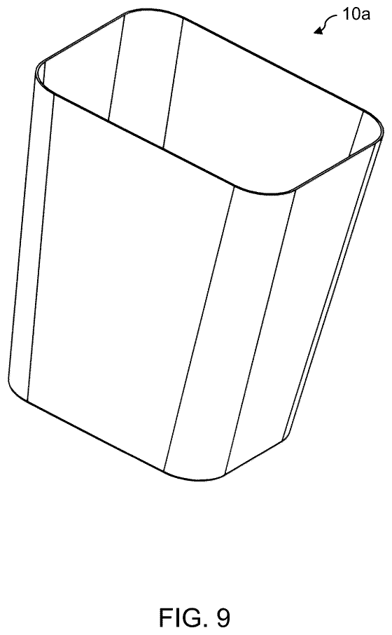

FIG. 9 depicts a top isometric view of a trash bin 10a without a rim. The trash bin 10a may be similar to the trash bin 10; however, the trash bin 10a may not include the rim 14. Stated another way, the trash bin 10a may be a “rimless” trash bin. In the present disclosure, the term “rimless” is used to describe a trash bin that does not include the outwardly curving section on the top periphery of the trash bin (as included in the trash bin 10 depicted in FIG. 1). In some aspects, a trash bin with straight sides thus may have a “rim” in the conventional sense as referring to the uppermost periphery of its side walls, but may be considered “rimless” in this instance/disclosure if it lacks the outwardly curving structure on the top edges of its walls which may serve as a holder for the trash bin, as depicted in FIG. 1 and described above.

Remaining details of the trash bin 10a are similar to the details of the trash bin 10, and hence are not described again here for the sake of simplicity and conciseness.

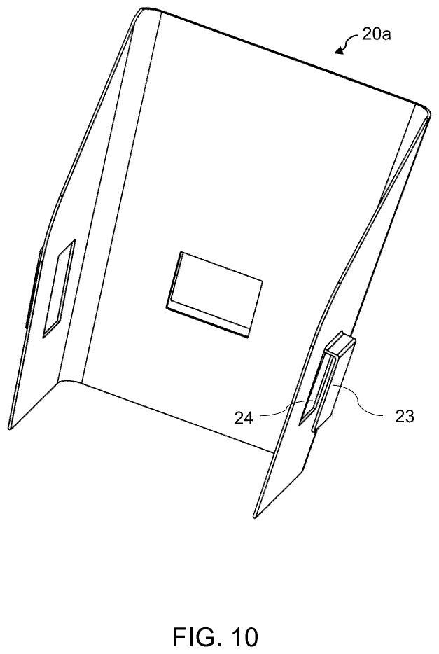

FIG. 10 depicts an isometric view of another trash bin backboard apparatus 20a (or apparatus 20a) in accordance with the present disclosure. The apparatus 20a may be similar to the trash bin backboard apparatus described above in conjunction with FIG. 2; however, the apparatus 20a may be configured to be secured to the rimless trash bin 10a.

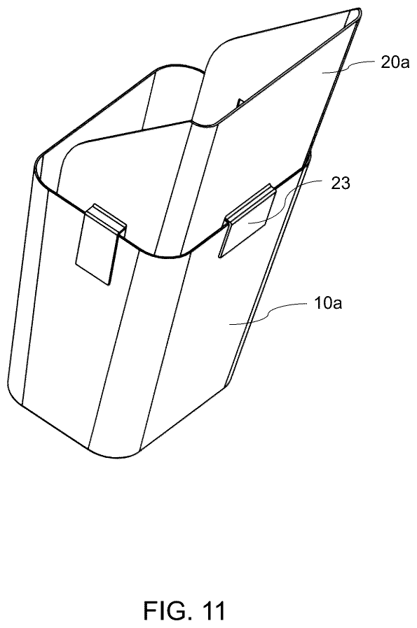

In some aspects, the apparatus 20a may include connectors or fingers 23 that may be formed at center portions of the back wall and/or the side walls of the apparatus 20a. The fingers 23 serve to attach the apparatus 20a to the rimless trash bin 10a. The fingers 23 may be formed from a wall of the apparatus 20a leaving behind an aperture 24, or may be separate pieces, or formed in an alternative way that does not leave an aperture behind it. The space between the fingers 23 and the wall of the apparatus 20a forms a narrow pocket into which a wall of the trash bin 10a fits and is trapped, thus attaching the apparatus 20a firmly to the trash bin 10a. The width of the “pocket” may be comparable to the thickness of the wall of the trash bin 10a, ensuring a snug fit as shown in FIG. 11. Stated another way, the dimensions of these pockets are similar to the thickness of the wall of the trash bin 10a such that the walls of the trash bin 10a enter into these pockets and are trapped within it, thus fastening the apparatus 20a to the trash bin 10a and acting to prevent it from being toppled by thrown trash.

FIG. 11 depicts an isometric view of the apparatus 20a secured in the trash bin 10a, in accordance with the present disclosure. Specifically, FIG. 11 depicts the apparatus 20a with the fingers 23 overlapping the upper periphery of the rimless trash bin 10a and extending to the outside of the trash bin 10a. The fingers 23 overlap the periphery of the trash bin 10a, while the base of the apparatus 20a is inside the trash bin 10a. The apparatus 20a is thus inside the trash bin 10a and attached and secured to it. The aspect described herein includes one finger on each of the three broadest sides of the apparatus 20a; however, the count of fingers may be varied based on the size of the trash bin 10a or other factors.

In some aspects, the portion of the apparatus walls disposed outside the trash bin 10a and above the top periphery of the trash bin 10a may be less than 70% of a length of the apparatus 20a (or “base length”). Stated another way, more than 30% of the apparatus/base length may be secured inside the interior portion of the trash bin 10.

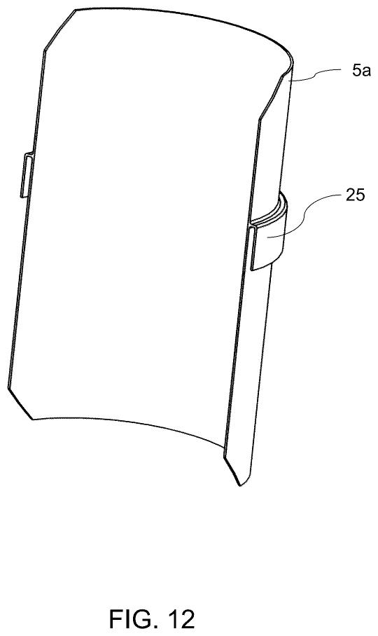

FIG. 12 depicts a second semi-circular trash bin backboard apparatus 5a (or apparatus 5a) with an attached connector 25 on the convex side (or exterior side) of the curved apparatus 5a, in accordance with the present disclosure. The connector 25 is made of fingers (similar to the fingers 23 described above) attached to the apparatus 5a that forms a pocket with the walls of the apparatus 5a into which the rim of a trash bin may be retained and secured, when the base of the apparatus 5a is placed inside the trash bin.

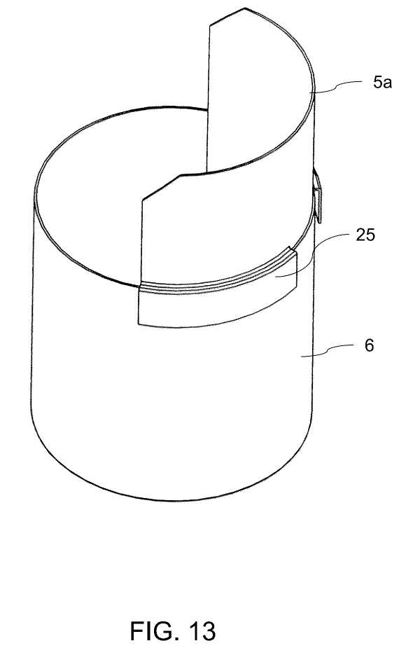

FIG. 13 depicts the apparatus 5a attached to the rimless trash bin 6. The curved walls of the connector 25 form a pocket into which the uppermost edges of the sides of the trash bin 6 fit and are retained. In some aspects, the connector 25 may be thought of as a very wide finger as previously described. It may be attached continuously around the wall of the apparatus 5a, or it may be in sections as shown in FIG. 13. The base of the apparatus 5a may be inside the trash bin 6 in the instance depicted in FIG. 13.

In some aspects, the portion of the apparatus walls disposed outside the trash bin 6 and above the top periphery of the trash bin 6 may be less than 70% of a length of the apparatus 5a (or “base length”). Stated another way, more than 30% of the apparatus/base length may be secured inside the interior portion of the trash bin 5a.

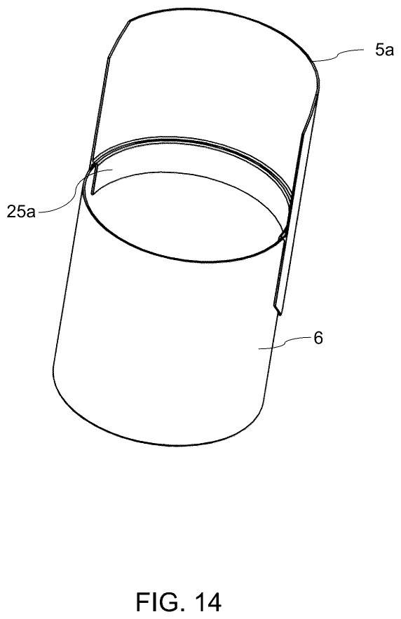

FIG. 14 depicts the apparatus 5a in which a connector 25a is on the inside (i.e., the concave portion) of the base wall of the apparatus 5a. The apparatus 5a may be attached to the outside of the trash bin 6 by means of the connector 25a that overlaps the top wall of the trash bin 6 and is substantially inside the trash bin 6. The base of the apparatus 5a is outside the trash bin 6 in the instance depicted in FIG. 14. The connector 25a may be disposed on an interior surface or concave surface of the apparatus 5a.

In some aspects, the portion of the apparatus walls disposed outside the trash bin 6 and above the top periphery of the trash bin 6 is less than 70% of a length of the apparatus 5a (or “base length”).

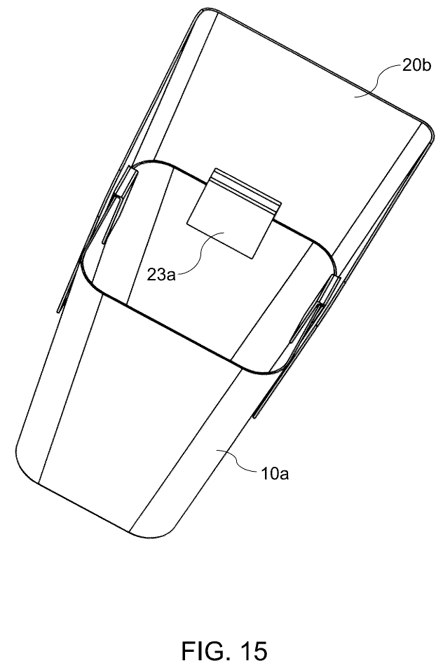

FIG. 15 depicts a trash bin backboard apparatus 20b (or apparatus 20b, which may be similar to the apparatus 20a) where the base of the apparatus 20b is disposed outside of the trash bin 10a and a connector 23a overhangs an upper periphery of the walls of the trash bin 10a so that the base is attached to the trash bin 10a from the outside (i.e., secured to a trash bin exterior wall), by the connector 23a which reaches into the trash bin 10a. The base of the apparatus 20b is outside the trash bin 10a in the instance depicted in FIG. 15. Stated another way, the base of the apparatus 20b is disposed outside of the trash bin 10a and secured to the trash bin exterior wall in the instance depicted in FIG. 15.

In some aspects, the portion of the apparatus walls disposed outside the trash bin 10a and above the top periphery of the trash bin 10a is less than 70% of a length of the apparatus 20b (or “base length”).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A trash bin backboard apparatus comprising:
a base, wherein:
the base comprises one or more walls,
the base is configured to be shaped as a chute by folding the one or more walls,
the base is configured to be secured in an interior portion of a trash bin such that exterior surfaces of the one or more walls face interior surfaces of one or more trash bin walls,
the one or more trash bin walls are rigid, and
at least a portion of the one or more walls is disposed outside the trash bin and above a top periphery of the trash bin when the base is secured in the interior portion of the trash bin, wherein a bottom edge of at least one wall of the one or more walls touches a bottom interior surface of the trash bin when the base is secured in the interior portion of the trash bin.

2. The trash bin backboard apparatus of claim 1, wherein the one or more walls comprise a first wall, a second wall and a third wall.

3. The trash bin backboard apparatus of claim 2, wherein the first wall, the second wall and the third wall form an integrated structure of the base.

4. The trash bin backboard apparatus of claim 2, wherein a first intersection edge of the first wall and the second wall is flexible, and wherein the first wall and the second wall are configured to be moved relative to each other via the first intersection edge such that a plane of the first wall forms a first predefined angle relative to a plane of the second wall.

5. The trash bin backboard apparatus of claim 4, wherein a second intersection edge of the third wall and the second wall is flexible, and wherein the third wall and the second wall are configured to be moved relative to each other via the second intersection edge such that a plane of the third wall forms a second predefined angle relative to the plane of the second wall.

6. The trash bin backboard apparatus of claim 5, wherein the first predefined angle is equivalent to the second predefined angle.

7. The trash bin backboard apparatus of claim 6, wherein the first predefined angle and the second predefined angle are equivalent to 90 degrees.

8. The trash bin backboard apparatus of claim 5, wherein the first predefined angle and the second predefined angle are based on a shape of the interior portion of the trash bin.

9. A trash bin backboard apparatus comprising:
a base, wherein:
the base comprises one or more walls,
the base is configured to be shaped as a chute by folding the one or more walls,
the base is configured to be secured in an interior portion of a trash bin such that exterior surfaces of the one or more walls face interior surfaces of one or more trash bin walls,
the one or more trash bin walls are rigid, and
at least a portion of the one or more walls is disposed outside the trash bin and above a top periphery of the trash bin when the base is secured in the interior portion of the trash bin; and
a connector originating from a middle section of at least one wall from the one or more walls, wherein the connector is configured to attach the at least one wall to a top portion of at least one trash bin wall.

10. The trash bin backboard apparatus of claim 9, wherein the base is semi-circular in shape and the trash bin is circular in shape, and wherein the connector is disposed on an exterior or convex surface of the at least one wall.

11. The trash bin backboard apparatus of claim 9, wherein the connector is formed of a folded cut-out section of the at least one wall.

12. The trash bin backboard apparatus of claim 9, wherein the connector is shaped as a wedge and configured to be positioned under a rim of the trash bin.

13. The trash bin backboard apparatus of claim 9, wherein the connector comprises a locking mechanism configured to lock the connector with the top portion of the at least one trash bin wall.

14. The trash bin backboard apparatus of claim 13, wherein the locking mechanism comprises an adhesive.

15. The trash bin backboard apparatus of claim 13, wherein the locking mechanism comprises a Velcro™ tape.

16. The trash bin backboard apparatus of claim 13, wherein the locking mechanism comprises one or more snap buttons.

17. The trash bin backboard apparatus of claim 13, wherein the locking mechanism comprises a protrusion-and-hole locking arrangement.

18. The trash bin backboard apparatus of claim 1, wherein the exterior surfaces of the one or more walls touch the interior surfaces of one or more trash bin walls when the base is secured in the interior portion of the trash bin.

19. The trash bin backboard apparatus of claim 1, wherein the trash bin is circular in shape, wherein the base is semi-circular in shape, and wherein the base is wedged and secured inside the trash bin such that the base tightly fits a trash bin wall.

20. A trash bin backboard apparatus comprising:
a base, wherein:
the base comprises one or more walls,
the base is configured to be shaped as a chute by folding the one or more walls,
the base is configured to be disposed outside of a trash bin and secured to a trash bin exterior wall,
the trash bin exterior wall is rigid, and
at least a portion of the one or more walls is disposed outside the trash bin and above a top periphery of the trash bin; and
a connector disposed on a middle section of at least one wall of the one or more walls, wherein the connector is configured to attach the at least one wall to a top portion of at least one trash bin wall.

21. The trash bin backboard apparatus of claim 20, wherein the base is semi-circular in shape and the trash bin is circular in shape, and wherein the connector is disposed on an interior or concave surface of the at least one wall.

22. The trash bin backboard apparatus of claim 13, wherein the connector is an extension piece of the base, and is folded into opposing leaves that form a wedge in the middle, the connector extending from above the rim of a trash bin to a position beneath the rim of the trash bin, the wedge fitting under the rim of the trash bin, and the locking element being disposed between the leaves, so that the wedge is secured in place by the locking element when the leaves are pressed together.
